(19) United States
(12) Patent Application Publication
(10) Pub. No.: US 2012/0150468 A1
(43) Pub. Date: Jun. 14, 2012

(54) Method and System for Estimating and Tracking Frequency and Phase Angle of 3-Phase Power Grid Voltage Signals

(76) Inventors: Zafer Sahinoglu, Boston, MA (US); Ming Sun, Sunnyvale, CA (US); Koon Hoo Teo, Lexington, MA (US)

(21) Appl. No.: 12/967,909

(22) Filed: Dec. 14, 2010

(51) Int. Cl. G06F 19/00; G06F 17/14; G06F 17/10

(52) U.S. Cl. 702/72; 708/300; 708/400

(57) ABSTRACT

A method estimates parameters of 3-phase voltage signals to synchronize a power grid in a presence of a voltage unbalance by transforming the 3-phase voltage signals to αβ-reference signals using a Clark transformation matrix, and estimating sinusoidal signals and corresponding quadrature signals of the αβ-reference signals using an extended Kalman filter, and determining a phase angle of a positive sequence based on a relationship of the phase angle to the estimated the sinusoidal signals.

### FIELD OF THE INVENTION

This invention relates generally to power grids and in particular to estimating and tracking parameters of 3-phase voltage signals in the power grid.

### BACKGROUND OF THE INVENTION

Synchronization in a utility power grid is a critical issue for the purpose of control and operation when distributed power generators are connected to the grid. The basic task of grid synchronization is to determine a phase angle of a 3-phase voltage signals in the grid.

In the presence of a voltage unbalance, this becomes difficult because the unbalanced 3-phase signal is composed of positive, negative and zero sequences. The object is to detect the phase angle of the positive sequence instead of the original signal. Although a state-of-the-art phase locked loop (PLL) works well under most abnormal grid conditions, PPL suffers from performance degradation in the presence of the voltage unbalance because a double frequency component is introduced due to the existence of a negative sequence.

In practice, the frequency in the grid can deviate from a nominal frequency, which makes the task difficult. A number of methods are known for detecting the phase angle of the grid signal in the presence of the voltage unbalance. A commonly used method is based on extracting of the positive sequence by the application of a symmetrical component transformation. If there is frequency variation, then the grid frequency can be tracked to improve the performance.

FIG. 1 shows a conventional method 100 for estimating and tracking the frequency of a sinusoidal voltage signal using an extended Kalman filter. Input 110 to the method is a 1-phase voltage signal

vₐ(n)=Vₐ cos(nw+φₐ)+eₐ(n).

An all-pass filter and extended Kalman filter based frequency tracker 120 is applied to the input to obtain an estimate the frequency ŵ(n) 130 of the single sinusoidal signal after observing the n^{th} sample.

### SUMMARY OF THE INVENTION

The embodiments of the invention provide a method for synchronizing and determining a phase angle of a 3-phase voltage signals in a power grid in the presence of a voltage unbalance. Both the amplitude and the phase unbalance are considered.

Instead of processing the 3-phase voltage signals in an abc natural reference frame, the method separates the positive and negative sequences in the transformed stationary reference frame by applying a Clarke transformation to the 3-phase voltage signal.

As a result, an explicit expression of the phase angle of the positive sequence is obtained. By selecting the in-phase and quadrature sinusoidal signals with the grid frequency as the state variables, an extended Kalman filter based tracking method is applied to estimate and track the phase angles and frequencies.

### BRIEF DESCRIPTION OF THE DRAWINGS

FIG. 1 is a flow diagram of a conventional method for estimating and tracking a frequencies of a sinusoidal signal using an extended Kalman filter in a power grid;

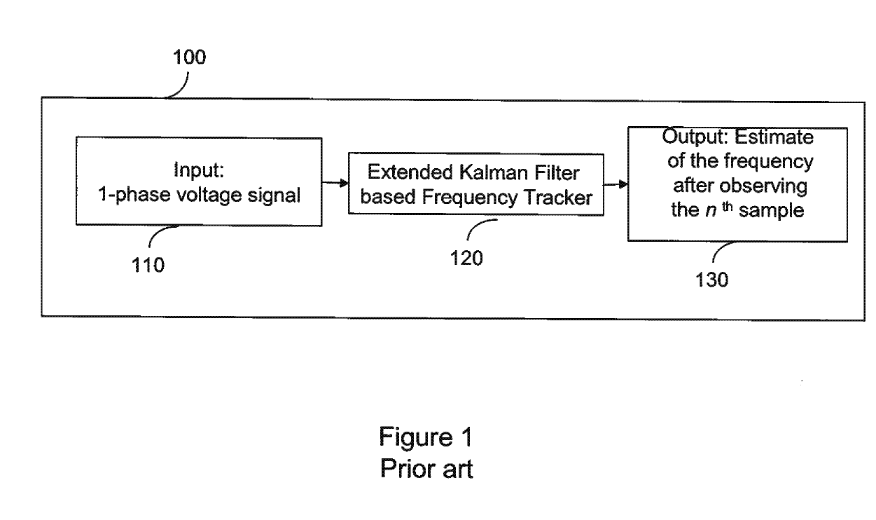

FIG. 2 is a flow diagram of a method for estimating and tracking frequencies and phase angles of the 3-phase voltage signals of a power grid in a transform domain using an extended Kalman filter according to embodiments of the invention;

FIG. 3 is a flow diagram of a method for transforming 3-phase voltage signals to αβ-reference signals via a Clark transformation according to embodiments of the invention; and

FIG. 4 is a schematic of an extended Kalman filter applied to αβ-reference signals for estimating and tracking phase angles and frequencies according to embodiments of the invention.

### DETAILED DESCRIPTION OF THE PREFERRED EMBODIMENTS

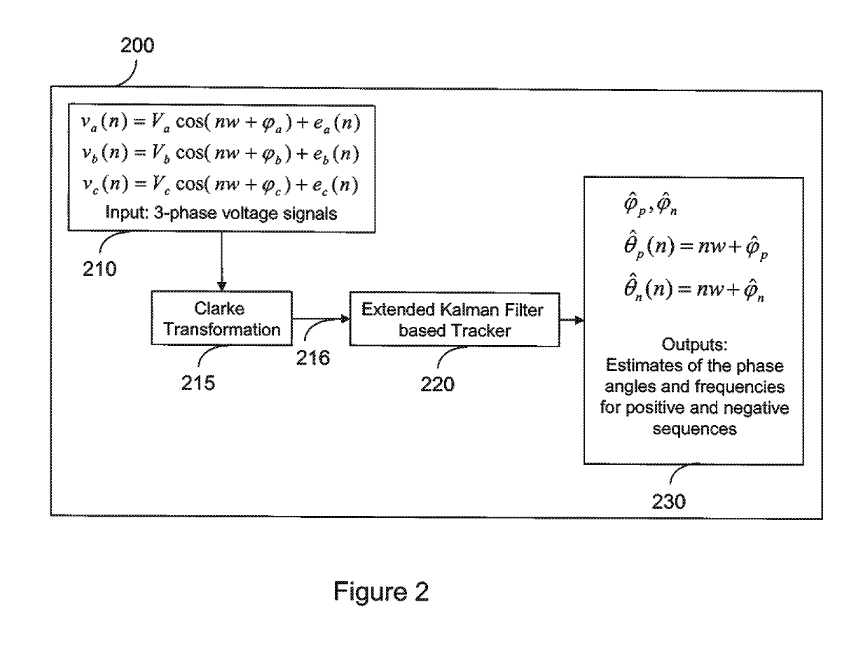

As shown in FIG. 2, the embodiments of our invention provide a method 200 for estimating and tracking frequencies and phase angles of the 3-phase voltage signals of a utility power grid in a transform domain using an extended Kalman filter 220.

Inputs 210 to the method are 3-phase voltage signals 210 of the power grid are measured and utilized for the purpose of grid synchronization. In the presence of a voltage unbalance, the discrete 3-phase voltage signals corrupted by additive noise are expressed as

Vₐ(n)=Vₐ cos(nw+φₐ)+eₐ(n)

v_{b}(n)=V_{b} cos(nw+φ_{b})+e_{b}(n)

v_{c}(n)=V_{c} cos(nw+φ_{c})+e_{c}(n), (1)

where n is an instant in time instant for i=a, b, c, Vᵢ is an amplitude, and φᵢ is an initial phase angle of the phase i, w is an angula frequency of the power grid given by w=2πf/f_{S} where f and f_{S} are a grid frequency and a sampling frequency, respectively, and e is additive noise.

The additive noise at time instant n is

e(n)=[eₐ(n),e_{b}(n),e_{c}(n)]^{T},

where T is a transpose operator. The noise is assumed to be a zero-mean Gaussian random vector with covariance matrix Q. The noise vectors at different time instants are uncorrelated.

According to Fortescue's theorem, the 3-phase grid voltage signals 210 can be rewritten as

v(n)=vₚ(n)+vₙ(n)+v₀(n)+e(n),

where vₚ(n), vₙ(n) and v₀(n) represent the positive sequence, a negative sequence, and a zero sequence respectively defined by

$${v}_{p} ( n ) = {{V}_{p} [ cos {θ}_{p} ( n ) , cos ( {θ}_{p} ( n ) - \frac{2 π}{3} ) , cos ( {θ}_{p} ( n ) + \frac{2 π}{3} ) ]}^{T} \\ {v}_{n} ( n ) = {{V}_{n} [ cos {θ}_{n} ( n ) , cos ( {θ}_{n} ( n ) + \frac{2 π}{3} ) , cos ( {θ}_{n} ( n ) - \frac{2 π}{3} ) ]}^{T} \\ {v}_{0} ( n ) = {{V}_{0} [ cos {θ}_{0} ( n ) , cos {θ}_{0} ( n ) , cos {θ}_{0} ( n ) ]}^{T} , \qquad ( 2 )$$

where Vᵢ and θᵢ(n) for i=p, n, 0 are the amplitude and phase angle of each sequence, respectively.

According to embodiments of the invention, an estimate 230 of phase angles θₚ(n) is obtained by the following steps:
(a) transform the 3-phase voltage signals 210 to αβ-reference signals 216 using a Clark transformation matrix 215;
(b) estimate the sinusoidal signals and corresponding quadrature signals of the αβ-reference signals using the extended Kalman filter 220; and
(c) determine 230 a phase angle of a positive sequence based on a relationship of the phase angle to the estimated sinusoidal signals.

Clark Transformation

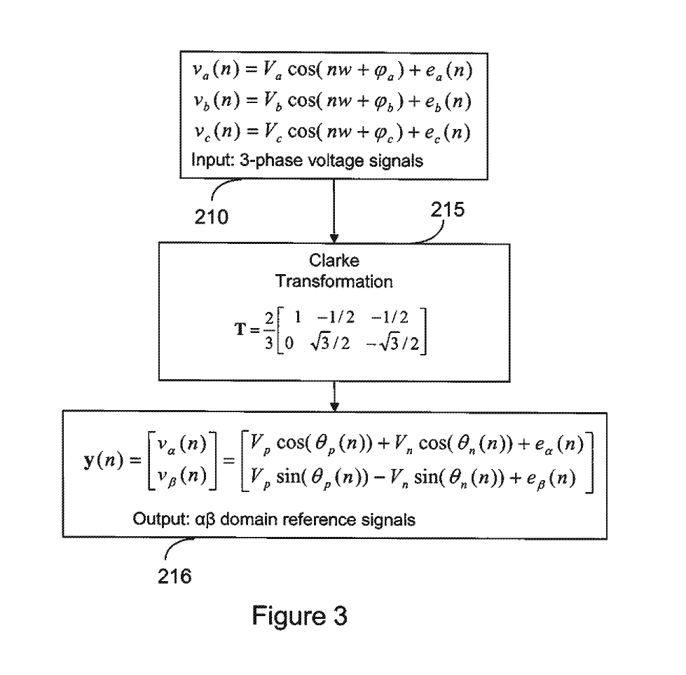

As shown in FIG. 3, after applying the Clarke transformation 215 to equation (1), we obtain the corresponding signal in αβ-reference frame signals 216 first represented as

$${[ {v}_{α} ( n ) , {v}_{β} ( n ) ]}^{T} = {T [ {v}_{a} ( n ) , {v}_{b} ( n ) , {v}_{c} ( n ) ]}^{T} , \\ where \\ T = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] \qquad ( 3 )$$

is the Clarke transformation matrix.

The resulting αβ-reference frame signals can then be represented by

$$y ( n ) = [ \begin{matrix}{v}_{α} ( n ) \\ {v}_{β} ( n )\end{matrix} ] = {V}_{p} [ \begin{matrix}cos {θ}_{p} ( n ) \\ sin {θ}_{p} ( n )\end{matrix} ] + {V}_{n} [ \begin{matrix}cos {θ}_{n} ( n ) \\ - sin {θ}_{n} ( n )\end{matrix} ] + [ \begin{matrix}{e}_{α} ( n ) \\ {e}_{β} ( n )\end{matrix} ] . \qquad ( 4 )$$

The covariance of the noise vector e_{αβ}(n)=[e_{α}(n),e_{β}(n)]^{T} is denoted as

Q_{αβ}=TQT^{T}.

The benefit of applying Clarke transformation is clear because the zero sequence is canceled, and the number of unknown nuisance parameters is reduced by two. Although the number of unknown parameters in equation (4) is reduced, equation (4) is still difficult to solve because equation (4) still contains two sinusoidal signals and is highly non-linear with respect to the unknown parameters.

Based on the fact that θₚ(n) and θₙ(n) have the same frequency, equation (4) can be rewritten as

$$\begin{matrix}{v}_{α} ( n ) = ( {V}_{p} cos {ϕ}_{p} + {V}_{n} cos {ϕ}_{n} ) cos ( nw ) - \\ ( {V}_{p} sin {ϕ}_{p} + {V}_{n} sin {ϕ}_{n} ) sin ( nw ) + {e}_{α} ( n ) \\ = {V}_{α} cos ( nw + {ϕ}_{α} ) + {e}_{α} ( n )\end{matrix} \\ \begin{matrix}{v}_{β} ( n ) = ( {V}_{p} sin {ϕ}_{p} - {V}_{n} sin {ϕ}_{n} ) cos ( nw ) - \\ ( - {V}_{p} cos {ϕ}_{p} + {V}_{n} cos {ϕ}_{n} ) sin ( nw ) + {e}_{β} ( n ) \\ = {V}_{β} cos ( nw + {ϕ}_{β} ) + {e}_{β} ( n ) .\end{matrix} \qquad ( 5 )$$

It can be seen from equation (5) that each phase in the αβ domain includes only one noise corrupted sinusoidal signal. The problem becomes estimating parameters of a single-tone sinusoidal signal.

After the parameters Vᵢ and φᵢ for i=α, β are obtained from v_{α}(n) and v_{β}(n), an estimate of the phase angle θₚ(n) can be determined based on the relationship given in equation (5).

Extended Kalman Filter Based Tracking

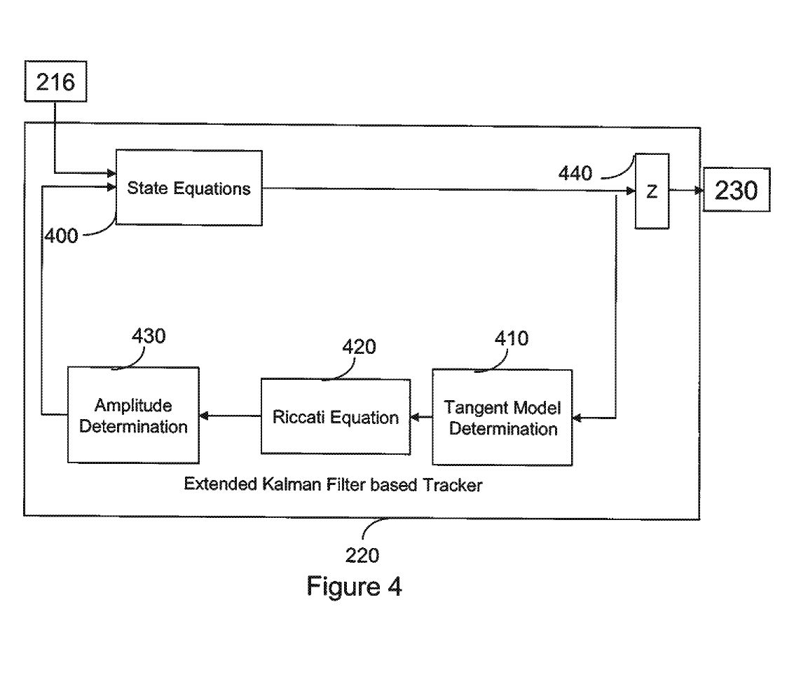

As shown in FIG. 4, the αβ-reference frame signals 216 are input to the extended Kalman filter 220.

As specified in equation (5), the unbalanced signals in the αβ domain 216 can be treated as two sinusoidal signals with unknown amplitudes, initial phases and slowly time-varying frequency. Hence, we define five state variables, where the in-phase and quadrature signals of each sinusoid are included and the last variable is the frequency as given below:

$$x ( n ) = [ \begin{matrix}{x}_{1} ( n ) \\ {x}_{2} ( n ) \\ {x}_{3} ( n ) \\ {x}_{4} ( n ) \\ {x}_{5} ( n )\end{matrix} ] = [ \begin{matrix}{V}_{α} cos ( nw + {ϕ}_{α} ) \\ {V}_{α} sin ( nw + {ϕ}_{α} ) \\ {V}_{β} cos ( nw + {ϕ}_{β} ) \\ {V}_{β} sin ( nw + {ϕ}_{β} ) \\ w\end{matrix} ] . \qquad ( 6 )$$

As a result, the state equations 400 can be modeled as

$$\begin{matrix}x ( n + 1 ) = [ \begin{matrix}{x}_{1} ( n + 1 ) \\ {x}_{2} ( n + 1 ) \\ {x}_{3} ( n + 1 ) \\ {x}_{4} ( n + 1 ) \\ {x}_{5} ( n + 1 )\end{matrix} ] \\ = [ \begin{matrix}{x}_{1} ( n ) cos ( {x}_{5} ( n ) ) - {x}_{2} ( n ) sin ( {x}_{5} ( n ) ) \\ {x}_{1} ( n ) sin ( {x}_{5} ( n ) ) + {x}_{2} ( n ) cos ( {x}_{5} ( n ) ) \\ {x}_{3} ( n ) cos ( {x}_{5} ( n ) ) - {x}_{4} ( n ) sin ( {x}_{5} ( n ) ) \\ {x}_{3} ( n ) sin ( {x}_{5} ( n ) ) + {x}_{4} ( n ) sin ( {x}_{5} ( n ) ) \\ ( 1 - ɛ ) {x}_{5} ( n ) + {e}_{w} ( n )\end{matrix} ] ,\end{matrix} \qquad ( 7 )$$

where the parameter E models slowly time-varying characteristic of the frequency, and e_{w}(n) is modeled as a Gaussian distributed random variable with zero-mean and variance q. According to definitions of the state variables, the observation signals 216 from equation (5) are related to the state variables by

v_{α}(n)=x₁(n)+e_{α}(n)

v_{β}(n)=x₃(n)+e_{β}(n). (8)

In vector form, we obtain

$$y ( n ) = Px ( n ) + {e}_{αβ} ( n ) , \\ where \\ y ( n ) = {[ {v}_{α} ( n ) , {v}_{β} ( n ) ]}^{T} , \\ and \\ P = [ \begin{matrix}1 & 0 & 0 & 0 & 0 \\ 0 & 0 & 1 & 0 & 0\end{matrix} ] . \qquad ( 9 )$$

The complete set of equations to estimate the state x(n) based on the measurement vector y(n) is as follows:

(a) state equations 400 as in FIG. 4;

\hat{x}(n|n)=f(\hat{x}(n−1|n−1))+K(n)(y(n)−Pf(\hat{x}(n−1|n−1))); (10)

(b) (b) Riccati equation 420 as

M(n+1)=F(n)(M(n)−K(n)PM(n))F^{T}(n)+qA; (11)

(c) (c) amplitude determinations 430

K(n)=M(n)P^{T}(Q_{αβ}+PM(n)P^{T})⁻¹, (12)

where K(n) is the weighting matrix, M(n+1) is the prediction mean-square-error matrix.

A tangent model determination 410 is performed as follows:

$$f ( \hat{x} ( n \vert n ) ) = [ \begin{matrix}{\hat{x}}_{1} ( n \vert n ) cos ( {\hat{x}}_{5} ( n \vert n ) ) - {\hat{x}}_{2} ( n \vert n ) sin ( {\hat{x}}_{5} ( n \vert n ) ) \\ {\hat{x}}_{1} ( n \vert n ) sin ( {\hat{x}}_{5} ( n \vert n ) ) + {\hat{x}}_{2} ( n \vert n ) cos ( {\hat{x}}_{5} ( n \vert n ) ) \\ {\hat{x}}_{3} ( n \vert n ) cos ( {\hat{x}}_{5} ( n \vert n ) ) - {\hat{x}}_{4} ( n \vert n ) sin ( {\hat{x}}_{5} ( n \vert n ) ) \\ {\hat{x}}_{3} ( n \vert n ) sin ( {\hat{x}}_{5} ( n \vert n ) ) + {\hat{x}}_{4} ( n \vert n ) cos ( {\hat{x}}_{5} ( n \vert n ) ) \\ ( 1 - ɛ ) {\hat{x}}_{5} ( n \vert n )\end{matrix} ] , \\ and , \\ F ( n ) = \frac{\partial f ( x )}{\partial x} {\vert}_{x = \hat{x} ( n \vert n )} = [ \begin{matrix}{F}_{1} ( n ) & {F}_{2} ( n )\end{matrix} ] {\vert}_{x = \hat{x} ( n \vert n )} , \\ where$$

$${F}_{1} ( n ) = [ \begin{matrix}cos {x}_{5} & - sin {x}_{5} & 0 & 0 \\ sin {x}_{5} & cos {x}_{5} & 0 & 0 \\ 0 & 0 & cos {x}_{5} & - sin {x}_{5} \\ 0 & 0 & sin {x}_{5} & cos {x}_{5} \\ 0 & 0 & 0 & 0\end{matrix} ] , and$$

$${F}_{2} ( n ) = {[ \begin{matrix}- {x}_{1} sin {x}_{5} - {x}_{2} cos {x}_{5} & {x}_{1} cos {x}_{5} - {x}_{2} sin {x}_{5} & - {x}_{3} sin {x}_{5} - {x}_{4} cos {x}_{5} & {x}_{3} cos {x}_{5} - {x}_{4} sin {x}_{5} & 1 - ɛ\end{matrix} ]}^{T}$$

Furthermore, A is a 5×5 matrix with zero elements except the most right bottom element is one.

Estimating the Phase Angles and Frequency (440 in FIG. 4)

After an estimate of x(n) at each time instant n, \hat{x}(n|n) is obtained, the estimate is used to determine the initial phase angle and amplitude of the positive sequence component according to equation (5)

$$\begin{matrix} {\hat{ϕ}}_{p} = {tan}^{- 1} \frac{{\hat{V}}_{α} sin {\hat{ϕ}}_{α} + {\hat{V}}_{β} cos {\hat{ϕ}}_{β}}{{\hat{V}}_{α} cos {\hat{ϕ}}_{α} - {\hat{V}}_{β} sin {\hat{ϕ}}_{β}} , \\ and & ( 13 ) \\ {\hat{V}}_{p} = \frac{1}{2} \sqrt{{( {\hat{V}}_{α} sin {\hat{ϕ}}_{α} + {\hat{V}}_{β} cos {\hat{ϕ}}_{β} )}^{2} + {( {\hat{V}}_{α} cos {\hat{ϕ}}_{α} - {\hat{V}}_{β} sin {\hat{ϕ}}_{β} )}^{2}} . \\ where & ( 14 ) \\ {\hat{V}}_{α} sin {\hat{ϕ}}_{α} = {\hat{x}}_{2} ( n \vert n ) cos ( ( n - 1 ) {\hat{x}}_{5} ( n \vert n ) ) - {\hat{x}}_{1} ( n \vert n ) sin ( ( n - 1 ) {\hat{x}}_{5} ( n \vert n ) ) , \\ {\hat{V}}_{α} cos {\hat{ϕ}}_{α} = {\hat{x}}_{2} ( n \vert n ) sin ( ( n - 1 ) {\hat{x}}_{5} ( n \vert n ) ) + {\hat{x}}_{1} ( n \vert n ) cos ( ( n - 1 ) {\hat{x}}_{5} ( n \vert n ) ) , \\ {\hat{V}}_{β} sin {\hat{ϕ}}_{β} = {\hat{x}}_{4} ( n \vert n ) cos ( ( n - 1 ) {\hat{x}}_{5} ( n \vert n ) ) - {\hat{x}}_{3} ( n \vert n ) sin ( ( n - 1 ) {\hat{x}}_{5} ( n \vert n ) ) , \\ {\hat{V}}_{β} cos {\hat{ϕ}}_{β} = {\hat{x}}_{4} ( n \vert n ) sin ( ( n - 1 ) {\hat{x}}_{5} ( n \vert n ) ) + {\hat{x}}_{3} ( n \vert n ) cos ( ( n - 1 ) {\hat{x}}_{5} ( n \vert n ) ) . & ( 15 )\end{matrix}$$

The phase angle of the positive sequence component is obtained as

\hat{θ}ₚ(n)=n\hat{x}₅(n|n)+\hat{φ}ₚ. (16)

As a by-product, the initial phase angle and amplitude of the negative sequence component are given by

$$\begin{matrix}{\hat{ϕ}}_{n} = {tan}^{- 1} \frac{{\hat{V}}_{α} sin {\hat{ϕ}}_{α} - {\hat{V}}_{β} cos {\hat{ϕ}}_{β}}{{\hat{V}}_{α} cos {\hat{ϕ}}_{α} + {\hat{V}}_{β} sin {\hat{ϕ}}_{β}} , \\ and & ( 17 ) \\ {\hat{V}}_{n} = \frac{1}{2} \sqrt{{( {\hat{V}}_{α} sin {\hat{ϕ}}_{α} - {\hat{V}}_{β} cos {\hat{ϕ}}_{β} )}^{2} + {( {\hat{V}}_{α} cos {\hat{ϕ}}_{α} + {\hat{V}}_{β} sin {\hat{ϕ}}_{β} )}^{2}} . & ( 18 )\end{matrix}$$

Accordingly, the phase angle of the negative sequence component is given by

\hat{θ}ₙ(n)=n\hat{x}₅(n|n)+\hat{φ}ₙ. (19)

An alternate approach to determine the phase angle of the positive sequence component is based on the following equalities:

Vₚ cos θₚ(n)=½(V_{α} cos(nw+φ_{α})−V_{β} sin(nw+φ_{β}))

Vₚ sin θₚ(n)=½(V_{α} sin(nw+φ_{α})+V_{β} cos(nw+φ_{β}))

Vₙ cos θₙ(n)=½(V_{α} cos(nw+φ_{α})+V_{β} sin(nw+φ_{β}))

Vₙ sin θₙ(n)=½(V_{α} sin(nw+φ_{α})−V_{β} cos(nw+φ_{β})). (20)

This can be verified from equation (5) if the noises are not present. Also note the state variables defined in equation (7). Hence, an estimate of the phase angle of the positive sequence component is obtained, based on the state variable estimate \hat{x}(n|n) as

$$\begin{matrix}{\hat{θ}}_{p} ( n ) = {tan}^{- 1} \frac{{\hat{x}}_{2} ( n \vert n ) + {\hat{x}}_{3} ( n \vert n )}{{\hat{x}}_{1} ( n \vert n ) - {\hat{x}}_{4} ( n \vert n )} , \\ and & ( 21 ) \\ {\hat{θ}}_{n} ( n ) = {tan}^{- 1} \frac{{\hat{x}}_{2} ( n \vert n ) - {\hat{x}}_{3} ( n \vert n )}{{\hat{x}}_{1} ( n \vert n ) + {\hat{x}}_{4} ( n \vert n )} . & ( 22 )\end{matrix}$$

The computation unit Z 440 returns the estimate of the parameters 230 including estimates

ŵ,\hat{φ}ₚ,\hat{V}ₚ,\hat{θ}ₚ(n),\hat{φ}ₙ,\hat{V}ₙ,\hat{θ}ₙ(n).

### EFFECT OF THE INVENTION

The invention provides a method and system for synchronizing and determining a phase angle of a 3-phase voltage signals in a power grid in the presence of voltage unbalance. Both the amplitude and the phase unbalance are considered.

A new extended Kalman filter based synchronization method is provided to track the phase angle of the utility grid. Instead of processing the 3-phase voltage signal in the abc natural reference frame and resorting to the symmetrical component transformation as in the conventional manner, the method according to the invention separates the positive and negative sequences in the transformed αβ stationary reference frame.

Based on the obtained expressions in the αβ domain, the extended Kalman filter tracks the in-phase and quadrature sinusoidal signals with an unknown frequency.

Then, an estimate of the phase angle of the positive sequence is obtained. As a by-product, estimates of the phase angle of the negative sequence and the grid frequency are also determined. Compared to conventional schemes for 3-phase systems, the present method has a simpler structure.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for estimating parameters of 3-phase voltage signals to synchronize a power grid in a presence of a voltage unbalance, comprising the steps of:
transforming the 3-phase voltage signals to αβ-reference signals using a Clark transformation matrix;
estimating sinusoidal signals and corresponding quadrature signals of the αβ-reference signals using an extended Kalman filter; and
determining a phase angle of a positive sequence based on a relationship of the phase angle to the estimated the sinusoidal signals.

2. The method of claim 1, wherein the 3-phase voltage signal is
vₐ(n)=Vₐ cos(nw+φₐ)+eₐ(n)
v_{b}(n)=V_{b} cos(nw+φ_{b})+e_{b}(n)
v_{c}(n)=V_{c} cos(nw+φ_{c})+e_{c}(n),
where n is an instant in time for i=a, b, c, V is an amplitude and φᵢ is an initial phase angle of the phase i, and w is an angula frequency of the grid given by w=2πf/f_{S} where f and fₛ are a grid frequency and a sampling frequency, respectively, and e is additive noise, wherein the additive noise at time instant n is
e(n)=[eₐ(n),e_{b}(n),e_{c}(n)]^{T},
where T is a transpose operator.

3. The method of claim 2, wherein the 3-phase grid voltage signals is represented by
v(n)=vₚ(n)+vₙ(n)+v₀(n)+e(n),
where vₚ(n), vₙ(n) and v₀(n) represent the positive sequence, a negative sequence, and a zero sequence.

4. The method of claim 3, wherein the αβ-reference frame signals is first represented by
$${[ {v}_{α} ( n ) , {v}_{β} ( n ) ]}^{T} = {T [ {v}_{a} ( n ) , {v}_{b} ( n ) , {v}_{c} ( n ) ]}^{T} , \\ where$$
$$T = \frac{2}{3} [ \begin{matrix}1 & - \frac{1}{2} & - \frac{1}{2} \\ 0 & \frac{\sqrt{3}}{2} & - \frac{\sqrt{3}}{3}\end{matrix} ]$$
is the Clarke transformation matrix, and the αβ-reference signals is then represented by
$$y ( n ) = [ \begin{matrix}{v}_{α} ( n ) \\ {v}_{β} ( n )\end{matrix} ] = {V}_{p} [ \begin{matrix}cos {θ}_{p} ( n ) \\ sin {θ}_{p} ( n )\end{matrix} ] + {V}_{n} [ \begin{matrix}cos {θ}_{n} ( n ) \\ - sin {θ}_{n} ( n )\end{matrix} ] + [ \begin{matrix}{e}_{α} ( n ) \\ {e}_{β} ( n )\end{matrix} ] .$$

5. The method of claim 4, wherein the extended Kalman filter further comprises:
determining state equations for the sinusoidal signals and corresponding quadrature signals;
determining a tangent model base on the state equations;
applying a Riccati equation to the tangent model; and
determining an amplitude of the sinusoidal signals and corresponding quadrature signals.
